(19) United States
(12) Patent Application Publication
(10) Pub. No.: US 2021/0279523 A1
(43) Pub. Date: Sep. 9, 2021

(54) APPARATUS FOR CLARIFYING OBJECT BASED ON DEEP LEARNING AND METHOD THEREOF

(71) Applicants: HYUNDAI MOTOR COMPANY, Seoul (KR); KIA MOTORS CORPORATION, Seoul (KR)

(72) Inventor: So Jin JANG, Goyang-si (KR)

(21) Appl. No.: 17/014,135

(22) Filed: Sep. 8, 2020

(30) Foreign Application Priority Data
Mar. 3, 2020 (KR) 10-2020-0026643

(51) Int. Cl. G06K 9/62; G06K 9/00

(52) U.S. Cl. CPC G06K 9/6262; G06K 9/6257; G06K 9/00805; G06K 9/6218; G06K 9/628

(57) ABSTRACT

An apparatus for classifying an object based on deep learning includes: a first deep learning device that performs deep learning for objects of a first class; a second deep learning device that performs deep learning for objects of a second class; and a controller that classifies objects on a road into the first class or the second class, classifies the objects classified into the first class for each type based on a learning result of the first deep learning device, and classifies objects classified into the second class based on a learning result of the second deep learning device.

### CROSS-REFERENCE TO RELATED APPLICATION

This application claims the benefit of priority to Korean Patent Application No. 10-2020-0026643, filed in the Korean Intellectual Property Office on Mar. 3, 2020, the entire contents of which are incorporated herein by reference.

### TECHNICAL FIELD

The present disclosure relates to classifying various objects on the road based on deep learning capable of achieving a high accuracy level.

### BACKGROUND

In general, deep learning or deep neural network may be a type of machine learning. An artificial neural network (ANN) with multiple layers may be composed between an input and an output to include a convolution neural network (CNN), a recurrent neural network (RNN), or the like depending on its structure, its problem to be addressed, and its purpose.

The deep learning or deep neural network is used to address various problems such as classification, regression, localization, detection, segmentation, and the like.

An existing technology of classifying objects on the road in an autonomous vehicle obtains high-definition data in the form of a point cloud using a Light Detection And Ranging (LiDAR) sensor, clusters points to generate an object in the form of a square pillar, and classifies the object as a car or a goods vehicle based on a width of the generated object.

The same object even varies in shape with a distance and direction from a host vehicle. An existing object classification technology performs a classification process based on a width of the object, which does not reflect such a characteristic, thus not classifying objects on the road to have high accuracy.

Details described in the background art are written to increase the understanding of the background of the present disclosure, which may include details rather than an existing technology well known to those skilled in the art.

### SUMMARY

The present disclosure has been made to solve the above-mentioned problems occurring in the prior art while advantages achieved by the prior art are maintained intact.

An aspect of the present disclosure provides an apparatus for classifying an object based on deep learning to calculate the ratio of width to length of each object with respect to objects in the form of a square pillar where LiDAR points are clustered, separately perform deep learning for the objects based on the ratio, and classify the objects on the road using the result of the deep learning to classify various objects on the road to have high accuracy.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus may include: a first deep learning device that performs deep learning for objects of a first class; a second deep learning device that performs deep learning for objects of a second class; and a controller that classifies objects on a road into the first class or the second class, classifies the objects classified into the first class for each type based on a learning result of the first deep learning device, and classifies the objects classified into the second class based on a learning result of the second deep learning device.

The controller may classify the objects into the first class or the second class based on the ratio of width to length of each of the objects.

The controller may classify objects, each of which has the ratio of width to length greater than a reference value, into the first class and may classify objects, each of which has the ratio of width to length less than or equal to the reference value, into the second class. In this case, the reference value may be 1.06.

The controller may classify each of the objects into one of a car, a goods vehicle, a two-wheeled vehicle, or a pedestrian.

Each of the objects may be an object in the form of a square pillar where light detection and ranging (LiDAR) points are clustered.

According to another aspect of the present disclosure, a method may include: performing, by a first deep learning device, deep learning for objects of a first class; performing, by a second deep learning device, deep learning for objects of a second class; classifying, by a controller, objects on a road into the first class or the second class; classifying, by the controller, the objects classified into the first class for each type based on a learning result of the first deep learning device; and classifying, by the controller, the objects classified into the second class for each type based on a learning result of the second deep learning device.

The classifying of the objects on the road into the first class or the second class may include classifying the objects based on the ratio of width to length of each of the objects.

The classifying of the objects on the road into the first class or the second class may include classifying objects, each of which has the ratio of width to length greater than a reference value, into the first class and classifying objects, each of which has the ratio of width to length less than or equal to the reference value, into the second class. In this case, the reference value may be 1.06.

The objects may include at least one of a car, a goods vehicle, a two-wheeled vehicle, or a pedestrian.

Each of the objects may be an object in the form of a square pillar where LiDAR points are clustered.

According to another aspect of the present disclosure, another apparatus may include: a first deep learning device that performs deep learning for objects, each of which has a ratio of width to length greater than a reference value; a second deep learning device that performs deep learning for objects, each of which has a ratio of width to length less than or equal to the reference value; and a controller that calculates the ratio of width to length of each of objects located on a road, classifies the objects based on a learning result of the first deep learning device when the calculated ratio of width to length is greater than the reference value, and classifies the objects based on a learning result of the second deep learning device when the calculated ratio of width to length is less than or equal to the reference value.

The controller may classify each of the objects as one of a car, a goods vehicle, a two-wheeled vehicle, or a pedestrian.

Each of the objects may be an object in the form of a square pillar where LiDAR points are clustered.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a configuration of an apparatus for classifying an object based on deep learning according to an embodiment of the present disclosure;

FIG. 2 is a drawing illustrating an object applied to an apparatus for classifying an object based on deep learning according to an embodiment of the present disclosure;

FIG. 3 is a drawing illustrating a detailed configuration of an apparatus for classifying an object based on deep learning according to an embodiment of the present disclosure;

FIG. 4 is a drawing illustrating a road image used in an apparatus for classifying an object based on deep learning according to an embodiment of the present disclosure;

FIG. 5A is a drawing illustrating the result of classifying objects on a road image of FIG. 4 based on a first reference value in an apparatus for classifying an object based on deep learning according to an embodiment of the present disclosure;

FIG. 5B is a drawing illustrating the result of classifying objects on a road image of FIG. 4 based on a second reference value in an apparatus for classifying an object based on deep learning according to an embodiment of the present disclosure;

FIG. 5C is a drawing illustrating the result of classifying objects on a road image of FIG. 4 based on a third reference value in an apparatus for classifying an object based on deep learning according to an embodiment of the present disclosure;

FIG. 6 is a drawing illustrating performance of an apparatus for classifying an object based on deep learning according to an embodiment of the present disclosure;

FIG. 7 is a flowchart illustrating a method for classifying an object based on deep learning according to an embodiment of the present disclosure; and

FIG. 8 is a block diagram illustrating a computing system for executing a method for classifying an object based on deep learning according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

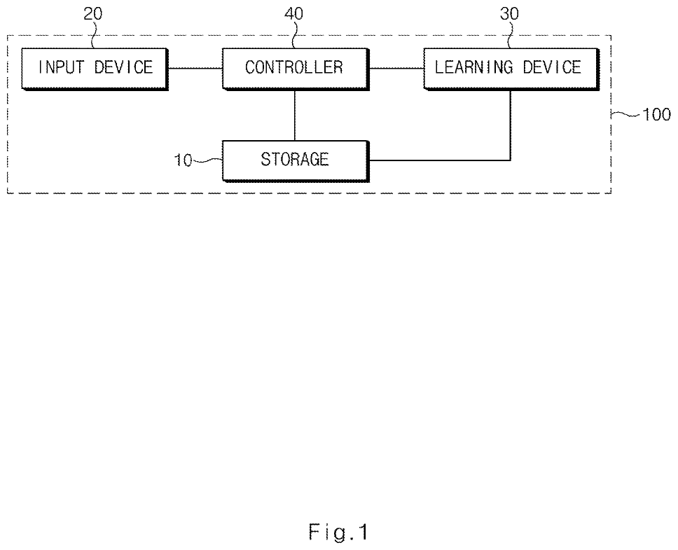

FIG. 1 is a drawing illustrating a configuration of an apparatus for classifying an object based on deep learning according to an embodiment of the present disclosure.

As shown in FIG. 1, an apparatus 100 for classifying an object based on deep learning according to an embodiment of the present disclosure may include a storage 10, an input device 20, a learning device 30, and a controller 40. In this case, the respective components may be combined into one component and some components may be omitted, depending on a manner which executes the apparatus 100 for classifying the object based on the deep learning according to an embodiment of the present disclosure. Particularly, the learning device 30 may be implemented to merge with the controller 40 such that the controller 40 performs a function of the learning device 30.

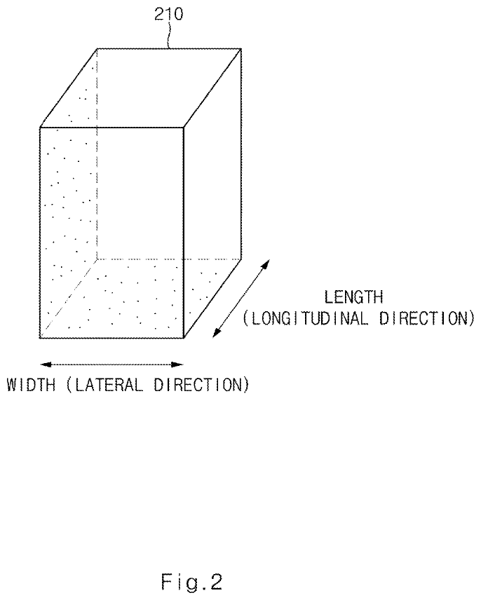

Seeing the respective components, first of all, the storage 10 may store various logics, algorithms, and programs, which are required in a process of calculating the ratio of width to length of each object with respect to objects in the form of a square pillar where light detection and ranging (LiDAR) points (a three-dimensional (3D) point cloud obtained by a LiDAR sensor) are clustered, separately performing deep learning for the objects based on the ratio, and classifying objects on the road using the result of the deep learning. Herein, as an example, the object is shown in FIG. 2.

FIG. 2 is a drawing illustrating an object applied to an apparatus for classifying an object based on deep learning according to an embodiment of the present disclosure.

As shown in FIG. 2, an object 210 in the form of a square pillar where LiDAR points are clustered may have a longitudinal length (a length in the heading direction of a vehicle) and a width (a length in a lateral direction). For reference, because a manner of clustering LiDAR points to generate the object 210 in the form of a square pillar is well known and commonly used and is not the gist of the present disclosure, it is fine to use any manner.

The storage 10 may separately store an algorithm of calculating the ratio of width to length of an object. In this case, the algorithm may include Equation 1 below.

R=D÷W [Equation 1]

Herein, R denotes the ratio, D denotes the length, and W denotes the width.

The storage 10 may separately store the result (the first learning result) of performing deep learning for objects, each of which has the ratio of width to length greater than a reference value (e.g., 1.06) and the result (the second learning result) of performing deep learning for objects, each of which has the ratio of width to length less than or equal to the reference value. In this case, the reference value may be randomly changed according to an intention of a designer.

The storage 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, or an optical disk.

The input device 20 may receive learning data required in a process of learning various obstacles (e.g., a car, a goods vehicle, a two-wheeled vehicle, a pedestrian, and the like) on the road. In this case, the input device 20 may receive an object, in the form of a square pillar where LiDAR points obtained from various obstacles on the road are clustered, as learning data.

The input device 20 may receive an object in the form of a square pillar where LiDAR points for various obstacles on the road are clustered in a process of classifying the various obstacles (objects) on the road.

Such an input device 20 may include a LiDAR sensor. The LiDAR sensor may be a type of environment sensor. When the LiDAR sensor is loaded into an autonomous vehicle to rotate and emit a laser pulse in all directions, it may measure location coordinates or the like of a reflector based on a time when the laser pulse is reflected and returned. In other words, after emitting a laser pulse (e.g., 70 KHz) to the front of a vehicle on the road, the LiDAR sensor may generate point cloud data from the reflected laser pulse.

Furthermore, the input device 20 may further include a camera, a radar sensor, a vehicle-to-everything (V2X) module, a detailed map, a global positioning system (GPS) receiver, and a vehicle network.

The camera may be mounted on the rear of an indoor rear-view mirror of the autonomous vehicle to capture an image including a lane, a vehicle, a person, or the like located around the autonomous vehicle.

The radar sensor may emit an electromagnetic wave and may receive the electromagnetic wave reflected from an object to measure a distance from the object, a direction of the object, or the like. Such radar sensors may be mounted on a front bumper and a rear side of the autonomous vehicle, may recognize an object in a long distance, and may be hardly affected by weather.

The V2X module may include a vehicle-to-vehicle (V2V) module (not shown) and a vehicle-to-infrastructure (V2I) module (not shown). The V2V module may communicate with a surrounding vehicle to obtain a location, a speed, acceleration, a yaw rate, a heading direction, or the like of another surrounding vehicle. The V2I module may obtain a shape of the road, a surrounding structure, or traffic light information from an infrastructure.

The detailed map may be a map for autonomous driving and may include lane, traffic light, or signpost information or the like to measure an accurate location of the vehicle and strengthen safety of autonomous driving.

The GPS receiver may receive GPS signals from three or more GPS receivers.

The vehicle network may be a network for communication between respective controllers in the autonomous vehicle and may include a controller area network (CAN), a local interconnect network (LIN), FlexRay, media oriented systems transport (MOST), an Ethernet, or the like.

The learning device 30 may separately perform deep learning for each of learning data input via the input device 20 under control of the controller 40.

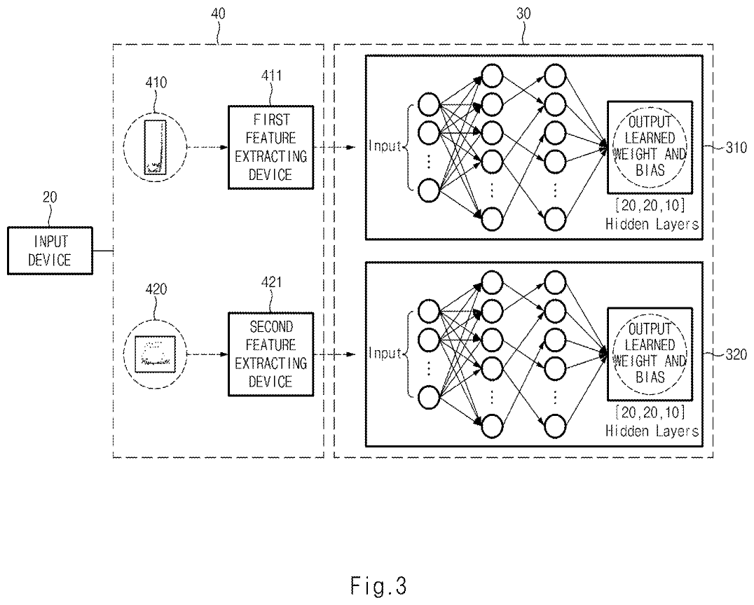

Such a learning device 30 may include a first deep learning device 310 of FIG. 3 for performing deep learning for objects, each of which has the ratio of width to length greater than a reference value, and a second deep learning device 320 of FIG. 3 for performing deep learning for objects, each of which has the ratio of width to length less than or equal to the reference value.

The controller 40 may perform overall control such that respective components may normally perform their own functions. Such a controller 40 may be implemented in the form of hardware, may be implemented in the form of software, or may be implemented in the form of a combination thereof. The controller 40 may be implemented as, but not limited to, a microprocessor.

Particularly, the controller 40 may perform a variety of control required in the process of calculating the ratio of width to length of each object with respect to objects in the form of a square pillar where LiDAR points are clustered, separately performing deep learning for the objects based on the ratio, and classifying the objects on the road using the result of the deep learning.

Hereinafter, the operation of the controller 40 will be described in detail with reference to FIG. 3.

FIG. 3 is a drawing illustrating a detailed configuration of an apparatus for classifying an object based on deep learning according to an embodiment of the present disclosure.

In a process of classifying objects used in deep learning, a controller 40 may calculate the ratio of width to length of each object using Equation 1 above with respect to objects in the form of a square pillar where LiDAR points input via the input device 20 are clustered, and may compare the calculated ratio of width to length of each object with a reference value.

A first feature extracting device 411 may extract a feature from an object 410 which has the ratio of width to length greater than the reference value and may input the extracted feature to a first deep learning device 310.

The first deep learning device 310 may be implemented as a feedforward neural network. The feedforward neural network may have three hidden layers, and the number of kernels of each hidden layer is [20, 20, 10]. The first deep learning device 310 may generate a weight and a bias as a first learning result. The first deep learning device 310 may determine a class based on the weight and bias, and features (eg, 91 Dimension Feature) extracted by the first feature extracting device 411. In this case, the first deep learning device 310 may output a class having the highest calculation result value.

A second feature extracting device 421 may extract a feature from an object 420 which has the ratio of width to length less than or equal to the reference value and may input the extracted feature to a second deep learning device 320.

The second deep learning device 320 may be implemented as a feedforward neural network. The feedforward neural network may have three hidden layers, and the number of kernels of each hidden layer is [20, 20, 10]. The second deep learning device 320 may generate a weight and a bias as a second learning result. The second deep learning device 320 may determine a class based on the weight and bias, and features (eg, 91 Dimension Feature) extracted by the second feature extracting device 421. In this case, the second deep learning device 320 may output a class having the highest calculation result value.

Herein, the feature extracted by the first feature extracting device 411 and the feature extracted by the second feature extracting device 421 are the same as each other and are shown in Tables 1 and 2 below. Furthermore, because the technology itself where the first feature extracting device 411 and the second feature extracting device 421 extract the features like Tables 1 and 2 below is well known and commonly used, no detailed description thereof will be provided.

TABLE 1

| Index | Feature |
|---|---|
| 1-2 | Width and length of object |
| 3-4 | Average X value and average Y value of object |
| 5 | the number of occupation points in object |
| 6 | Heading value of object |
| 7 | the number of occupation points in object × minimum |
| | measurement distance |
| 8 | Height of object |
| 9 | dispersion of Z values of points in object |
| 10-13 | Standard deviation (X, Y, Z) |
| 14-15 | Absolute speeds in X and Y directions of object |
| 16 | Radius of circle (average value of distances between host |
| | vehicle and points × angle median value with host vehicle) |
| 17 | Volume of object |
| 18-20 | Eigenvalues of points in voxel |
| 21-23 | Intensity maximum value, average value, dispersion |
| | value |
| 24-26 | Dimensionality (Scatterness, Linearness, Surfaceness) |
| 27 | After fitting points in object as one straight line, width along |
| | fit line axis |
| 28 | Height along fit line axis |
| 29 | Area along fit line axis |
| 30-38 | Eigenvector corresponding to each eigenvalue |

TABLE 2

| Index | Feature |
|---|---|
| 39-40 | Maximum Z value and minimum Z value of points in object |
| 41-42 | Distance and angle between X, Y, and Z coordinates and host |
| | vehicle (0, 0, 0) about object |
| 43 | Diagonal length on bird eye view (BEV) |
| 44 | Diagonal length based on 3D voxel |
| 45 | Find plane equation using eigenvector and plane and minimum |
| | distance among points in object |
| 46-50 | Object intensity histogram divided into 5 BINs |
| 51-60 | Height histogram divided into 10 BINs in X direction |
| 61-70 | Height histogram divided into 10 BINs in Y direction |
| 71-80 | Point number histogram divided into 10 BINs in X direction |
| 81-90 | Point number histogram divided into 10 BINs in Y direction |
| 91 | Maximum angle - minimum angle between host vehicle (0, 0, 0) |
| | and points in object |

Table 1 and 2 may include features representing the size of an object and features representing the shape (eg, side, back) of the object.

Next, as a process of classifying objects on the road using the result of deep learning performed by a learning device 30, a controller 40 may calculate the ratio of width to length of each object using Equation 1 above with respect to objects in the form of a square pillar where LiDAR points input via the input device 20 are clustered, and may compare the calculated ratio of width to length of each object with the reference value.

The controller 40 may independently perform a classification process for objects (first class objects), each of which has the ratio of width to length greater than the reference value and a classification process for objects (second class objects), each of which has the ratio of width to length less than or equal to the reference value. Herein, the classification process may refer to a process of classifying the object as one of a car, a goods vehicle, a two-wheeled vehicle, a pedestrian, or others (a median strip or the like). In this case, the car may include a sedan, a van, a sport utility vehicle (SUV), or the like. The goods vehicle may include a truck, a trailer, or the like.

The controller 40 may classify objects on the road, which have the ratio of width to length greater than the reference value, for each type based on a first learning result stored in the storage 10 and may classify objects on the road, which have the ratio of width to length less than or equal to the reference value, for each type based on a second learning result stored in the storage 10.

The controller 40 may calculate the ratio of width to length of an object located on the road, may classify the object based on the learning result of the first deep learning device 310 when the calculated ratio of width to length is greater than the reference value, and may classify the object based on the learning result of the second deep learning device 320 when the calculated ratio of width to length is less than or equal to the reference value. In this case, the learning result may include a weight, a bias, or the like.

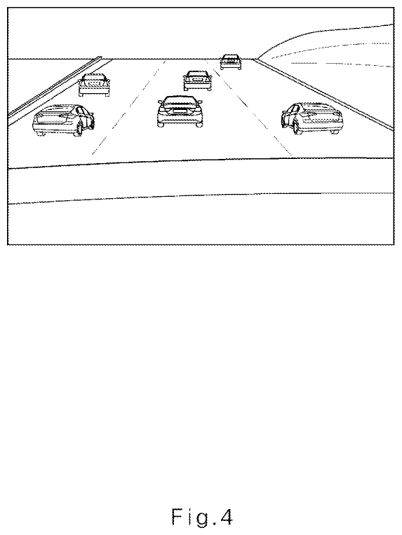

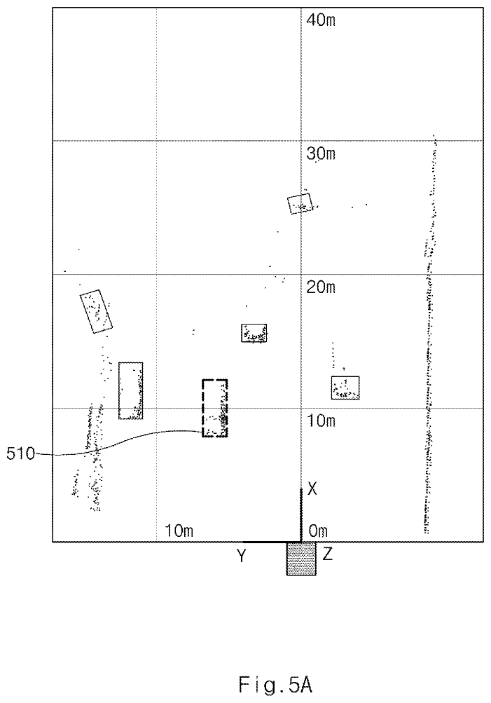

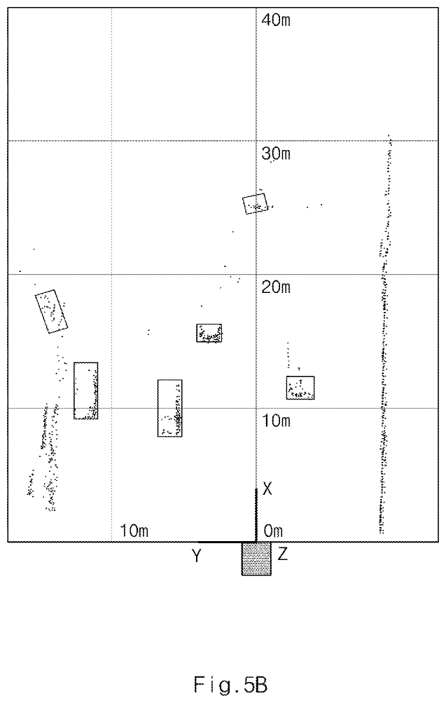

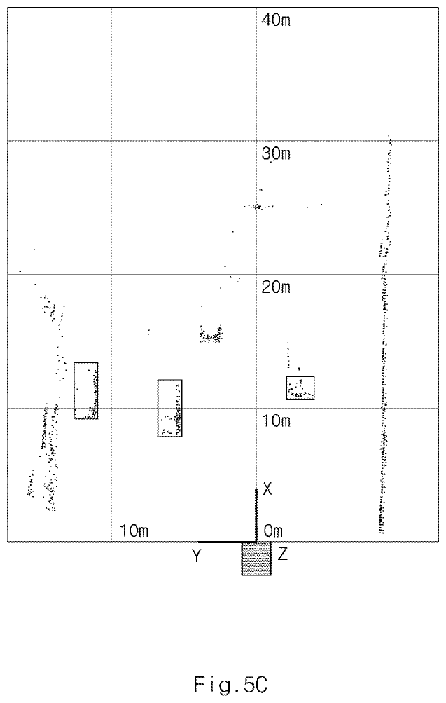

Hereinafter, a process of setting the reference value will be described with reference to FIG. 4 and FIGS. 5A to 5C.

FIG. 4 is a drawing illustrating a road image used in an apparatus for classifying an object based on deep learning according to an embodiment of the present disclosure.

As shown in FIG. 4, a plurality of cars are located as objects on the road. Thus, an apparatus 100 for classifying an object based on deep learning according to an embodiment of the present disclosure should classify all of objects on the road as cars.

FIG. 5A is a drawing illustrating the result of classifying objects on a road image of FIG. 4 based on a first reference value in an apparatus for classifying an object based on deep learning according to an embodiment of the present disclosure.

As shown in FIG. 5A, as a result of classifying a plurality of objects on a road image of FIG. 4 by applying the first reference value (e.g., 0.9), a controller 40 of FIG. 1 normally classifies most objects as cars (sold lines). However, although object 510 is the car, an error in which object 510 is classified as a goods vehicle (a dotted line) occurs. This means that some errors may occur in the process of classifying the objects when 0.9 is set as the firstference value.

FIG. 5B is a drawing illustrating the result of classifying objects on a road image of FIG. 4 based on a second reference value in an apparatus for classifying an object based on deep learning according to an embodiment of the present disclosure.

As shown in FIG. 5B, as a result of classifying a plurality of objects on a road image of FIG. 4 by applying the second reference value (e.g., 1.06), a controller 40 of FIG. 1 normally classifies all of objects as cars (sold lines). This means that an apparatus 100 for classifying an object based on deep learning according to an embodiment of the present disclosure may show the best performance when 1.06 is set as the second reference value.

FIG. 5C is a drawing illustrating the result of classifying objects on a road image of FIG. 4 based on a third reference value in an apparatus for classifying an object based on deep learning according to an embodiment of the present disclosure.

As shown in FIG. 5C, as a result of classifying a plurality of objects on a road image of FIG. 4 by applying the third reference value (e.g., 1.2), a controller 40 of FIG. 1 normally classifies most objects as cars (sold lines). However, an error in which some objects are not recognized as any of cars and goods vehicles occurs. This means that some errors may occur in the process of classifying the objects when 1.2 is set as the third reference value.

As a result, the reference value set in an apparatus 100 for classifying an object based on deep learning according to an embodiment of the present disclosure is 1.06. For reference, such a reference value may vary with a vehicle environment, a system environment, and various parameters.

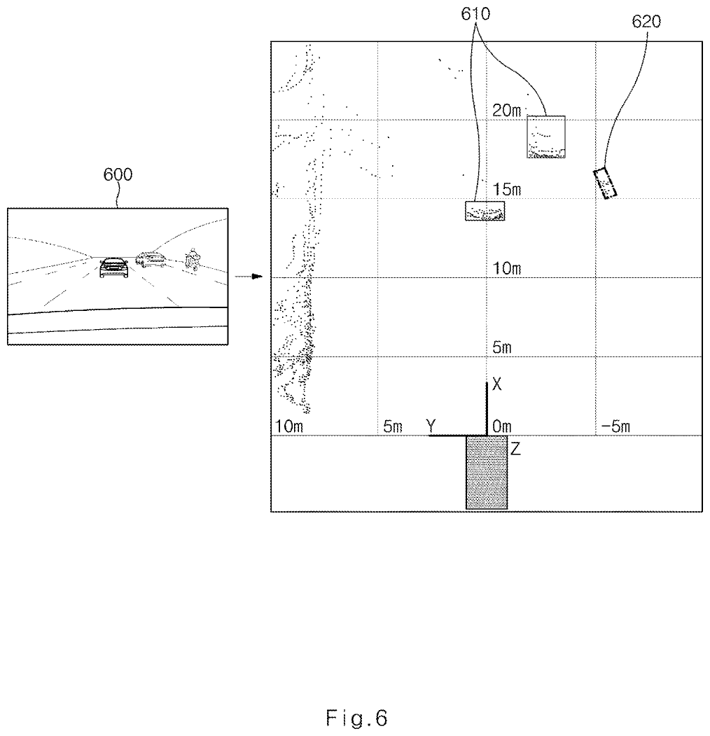

FIG. 6 is a drawing illustrating performance of an apparatus for classifying an object based on deep learning according to an embodiment of the present disclosure.

As shown in FIG. 6, a plurality of cars and a two-wheeled vehicle are located as objects in a road image 600.

As a result of classifying the objects in the road image 600, it may be seen that an object 610 is normally classified as a car and represented by a solid line, and it may be seen that an object 620 is normally classified as a two-wheeled vehicle and represented by an alternate long and short dash line. For reference, a car which is not classified in the road image 600 is an object which is not detected by a LIDAR sensor because it is located away from a host vehicle.

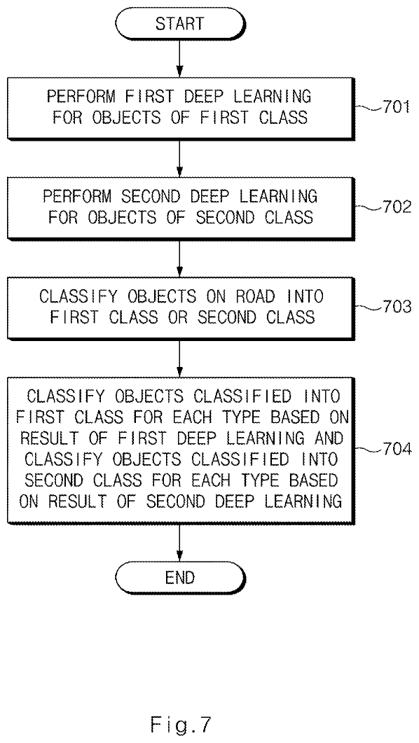

FIG. 7 is a flowchart illustrating a method for classifying an object based on deep learning according to an embodiment of the present disclosure.

In operation 701, a first deep learning device 310 of FIG. 3 may perform deep learning for objects of a first class.

In operation 702, a second deep learning device 320 of FIG. 3 may perform deep learning for objects of a second class.

Thereafter, in operation 703, a controller 40 of FIG. 3 may classify objects on the road into the first class or the second class. In this case, the objects on the road refer to objects obtained while an autonomous vehicle is actually traveling on the road (objects in the form of a square pillar where LiDAR points are clustered).

Thereafter, in operation 704, the controller 40 may classify the objects classified into the first class for each type based on the learning result of the first deep learning device 310 and may classify the objects classified into the second class for each type based on the learning result of the second deep learning device 320.

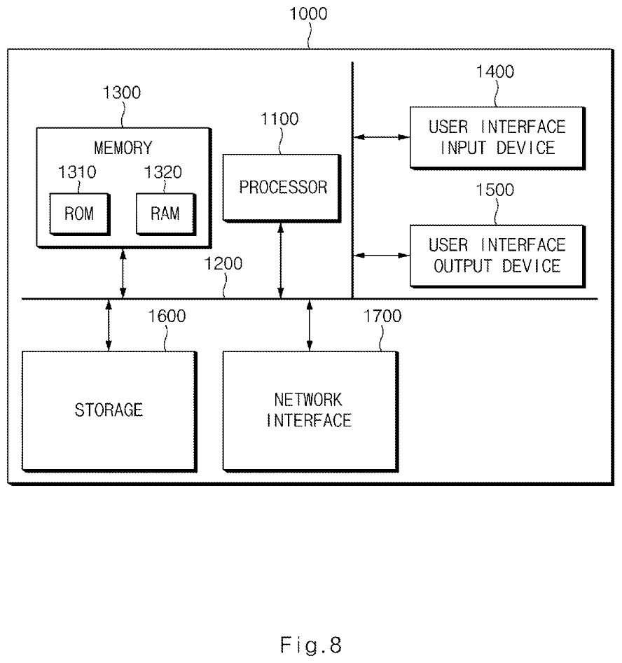

FIG. 8 is a block diagram illustrating a computing system for executing a method for classifying an object based on deep learning according to an embodiment of the present disclosure.

Referring to FIG. 8, the method for classifying the object based on the deep learning according to an embodiment of the present disclosure may be implemented by means of the computing system. A computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The apparatus for classifying the object based on deep learning and the method thereof according to an embodiment of the present disclosure may calculate the ratio of width to length of each object with respect to objects in the form of a square pillar where LiDAR points are clustered, may separately perform deep learning for the objects based on the ratio, and may classify the objects on the road using the result of the deep learning, thus classifying various objects on the road to have high accuracy.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for classifying an object based on deep learning, the apparatus comprising:
a first deep learning device configured to perform deep learning for objects of a first class;
a second deep learning device configured to perform deep learning for objects of a second class; and
a controller configured to:
classify objects on a road into the first class or the second class,
classify the objects classified into the first class for each type based on a learning result of the first deep learning device, and
classify the objects classified into the second class based on a learning result of the second deep learning device.

2. The apparatus of claim 1, wherein the controller classifies the objects on the road into the first class or the second class based on a ratio of width to length of each of the objects.

3. The apparatus of claim 1, wherein the controller classifies objects, each of which has a ratio of width to length greater than a reference value, into the first class, and classifies objects, each of which has a ratio of width to length less than or equal to the reference value, into the second class.

4. The apparatus of claim 1, wherein the controller classifies each of the objects into one of a car, a goods vehicle, a two-wheeled vehicle, or a pedestrian.

5. The apparatus of claim 1, wherein each of the objects has a square pillar shape in which Light Detection And Ranging (LiDAR) points are clustered.

6. A method for classifying an object based on deep learning, the method comprising:
performing, by a first deep learning device, deep learning for objects of a first class;
performing, by a second deep learning device, deep learning for objects of a second class;
classifying, by a controller, objects on a road into the first class or the second class;
classifying, by the controller, the objects classified into the first class for each type based on a learning result of the first deep learning device; and
classifying, by the controller, the objects classified into the second class for each type based on a learning result of the second deep learning device.

7. The method of claim 6, wherein the classifying objects on a road into the first class or the second class includes classifying the objects based on a ratio of width to length of each of the objects.

8. The method of claim 6, wherein the classifying objects on a road into the first class or the second class includes:
classifying objects, each of which has the ratio of width to length greater than a reference value, into the first class; and
classifying objects, each of which has the ratio of width to length less than or equal to the reference value, into the second class.

9. The method of claim 6, wherein the objects on the road include at least one of a car, a goods vehicle, a two-wheeled vehicle, or a pedestrian.

10. The method of claim 6, wherein each of the objects on the road has a square pillar shape in which Light Detection And Ranging (LiDAR) points are clustered.

11. An apparatus for classifying an object based on deep learning, the apparatus comprising:
a first deep learning device configured to perform deep learning for objects, each of which has a ratio of width to length greater than a reference value;
a second deep learning device configured to perform deep learning for objects, each of which has a ratio of width to length less than or equal to the reference value; and
a controller configured to:
calculate a ratio of width to length of each of objects located on a road,
classify the objects based on a learning result of the first deep learning device when the calculated ratio of width to length is greater than the reference value, and
classify the objects based on a learning result of the second deep learning device when the calculated ratio of width to length is less than or equal to the reference value.

12. The apparatus of claim 11, wherein the controller classifies each of the objects as one of a car, a goods vehicle, a two-wheeled vehicle, or a pedestrian.

13. The apparatus of claim 11, wherein each of the objects has a square pillar shape in which Light Detection And Ranging (LiDAR) points are clustered.
